(19) United States
(12) Patent Application Publication
(10) Pub. No.: US 2011/0268566 A1
(43) Pub. Date: Nov. 3, 2011

(54) METHOD FOR THE MANUFACTURE OF A CIRCULAR REVOLUTION THERMOMECHANICAL PART INCLUDING A TITANIUM-BASED LOAD-BEARING SUBSTRATE LINED WITH STEEL OR SUPERALLOY, A TURBOMACHINE COMPRESSOR HOUSING WHICH IS RESISTANT TO TITANIUM FIRE OBTAINED USING THIS METHOD

(75) Inventors: Laurent Ferrer, Lieusaint (FR); Claude Marcel Mons, Savigny Le Temple (FR)

(73) Assignee: SNECMA, Paris (FR)

(21) Appl. No.: 13/060,726

(22) PCT Filed: Sep. 3, 2009
(86) PCT No.: PCT/EP2009/061386

§ 371 Date: May 31, 2011

(30) Foreign Application Priority Data
Sep. 5, 2008 (FR) 08 55960

(51) Int. Cl. F01D 25/24; B23P 17/04

(52) U.S. Cl. 415/200; 29/888

(57) ABSTRACT

A method for manufacture of a compressor housing which is resistant to a titanium fire (burning titanium). A ring made of steel, steel alloy, or superalloy which is incombustible in the presence of a titanium fire is ring roll-bonded with a ring made from titanium or titanium alloy.

### TECHNICAL FIELD

The invention concerns the manufacture of a circular revolution thermomechanical part including a titanium-based load-bearing substrate lined with steel or superalloy.

It concerns more particularly the manufacture of a compressor housing which is resistant to titanium fire.

It also concerns a high-pressure axial compressor comprising such a housing and an aircraft engine, such as an aircraft turbojet fitted with such a housing.

### PRIOR ART

In a turbomachine such as an aircraft turbojet the high-pressure compressor housings must demonstrate their ability to resist a fire known as a “titanium fire”.

Such a titanium fire is caused by undesired friction appearing between a moving part, for example a rotor blade, made from titanium, of the compressor and a stationary titanium part of the compressor. This undesired friction may lead to local overheating of at least one of the parts in contact: a rotor blade or stationary part, which leads to volume combustion of the titanium alloy. The temperature of the burning liquid material (titanium or titanium alloy) may reach 2700° C. either locally in the friction zone, or inside the burning titanium particles which are projected in the airstream of the compressor from the friction zone. As a result, the melting points of the surrounding material brought into contact with the liquid titanium are exceeded, which thus generates fuel in the structure. This phenomenon is maintained by substantial pressures and oxygen flow rates, which are found at the airstream inlet in modern high-pressure compressors. Thus, in the case of new-generation turbojets requiring high pressures at the inlet of the high-pressure axial compressor, there is a potential risk of friction possibly leading to the combustion of titanium, for example between the first row of stator blades and the nozzle formed by the lower part of the rotor blades. Subsequently, the burning particles can be projected in the compressor airstream and reach the outer housing. In the past, titanium fires went as far as traversing all the way through housing walls, with the resulting prejudicial consequences. These consequences are particularly prejudicial since the titanium fire can only be extinguished by itself during the operation of a functioning turbojet.

To protect the compressor housings from titanium fires various solutions have already been proposed.

Certain thermal techniques for protecting housings used are either Draconian (elimination of titanium-based alloys and replacement by steels or nickel bases or bases of other materials), or sophisticated (installation of specific liners on the titanium- or titanium alloy-based housing, thermal protection accomplished by means of plasma, treatment of surfaces which are potentially in contact when the engine is in operation). One may cite as thermal protection liner-layers the solutions described in patents FR 2 560 640 and FR 2 560 641. However, these solutions prove to be heavy, cumbersome and sometimes limited over time, i.e. not compatible with lifetimes of turbomachines such as aircraft turbojets.

The literature also mentions non-combustible titanium alloys, but which have higher density than standard alloys. None of these alloy-based solutions said to be non-combustible has genuinely been validated at the time of writing.

The aim of the invention is thus to propose a solution enabling a turbomachine compressor housing to be protected from every titanium fire which might break out, whilst maintaining most of the advantages of titanium or of its conventional alloys (high mechanical resistance and low density).

### ACCOUNT OF THE INVENTION

To this end, the purpose of the invention is a method for the manufacture of a circular revolution thermomechanical part comprising a load-bearing substrate made from titanium or titanium alloy lined with a steel or a superalloy, wherein the following steps are taken:

a/ production of a titanium or titanium alloy preform having the general shape of an annular ring,

b/ production of a preform made from steel, steel alloy or superalloy which is incombustible in the presence of burning titanium, having the general shape of an annular ring of diameter less than the titanium or titanium alloy ring,

c/ machining and/or piercing at least of the inner surface of the titanium or titanium alloy ring,

d/ assembly of the ring made from steel, steel alloy or superalloy in the machined and/or pierced ring made from titanium or titanium alloy,

e/ ring rolling of at least the ring made from steel, steel alloy or superalloy until materials diffusion zones are created at the interface with the inner surface of the machined and/or pierced ring made from titanium or titanium alloy, where the process conditions of the rolling are such that the created diffusion zones have no fragile phases during any thermal treatment(s) and during the thermomechanical cycles to which the part is subsequently subjected.

According to the invention, a circular “roll-bonding” is accomplished between a steel, steel alloy or superalloy which is incombustible in the presence of titanium fire and a titanium or titanium alloy, under process conditions which enable diffusion zones to be obtained the resistance and tenacity of which are sufficient to withstand any thermal treatment and the subsequent thermomechanical cycles to which the part will be subject.

The technique used is that of a ring rolling, i.e. a method for hot- or cold-shaping of axisymmetric, annular parts without welding. Such a technique is, for example, described in the publication entitled “A summary of ring rolling technology. I—Recent trends in machines, processes and production lines”, bit. Mach. Tools Manufact. Vol. 32, no 3, 1992, P. 379-398, made by the authors Eruç E., Shivpuri R.

The solution according to the invention constitutes an effective response to the titanium fire, whilst retaining most of the intrinsic advantage of titanium, namely a low density and a high mechanical resistance, for the load-bearing structure.

According to an advantageous characteristic of the invention, step a/ is accomplished by pre-rolling or by alpha-beta forging in the beta field of a titanium alloy.

According to another advantageous characteristic, step b/ is accomplished by pre-rolling or by drawn rolled welded techniques or by forging-piercing of a steel, a steel alloy or a superalloy.

According to another advantageous characteristic, in step c/ the outer surface of the ring made from steel, steel alloy or superalloy is also machined and/or pierced.

According to an advantageous embodiment of the invention, in the course of step d/, a film made from anti-diffusion material(s) based on Mo, Ni or Sn is inserted between the ring made from steel, steel alloy or superalloy and the machined and/or pierced ring made from titanium or titanium alloy, where the thickness and chemical composition of the film are chosen both in order to produce a diffusion barrier between the titanium and the steel, steel alloy or superalloy, and to create diffusion zones between firstly the said film and the titanium or titanium alloy, and secondly the said film and the steel or superalloy.

Step e/ is preferably accomplished in the alpha-beta or beta field of the titanium or titanium alloy.

Also preferably, step e/ is accomplished by concomitant ring rolling of the ring made from steel, steel alloy or superalloy and the ring made from titanium or titanium alloy, where both rings are rolled one against the other by means of at least two rolling mandrels with vertical axes, each positioned outside one of the rings.

According to an additional characteristic, after step e/, when the steel is a low expansion coefficient steel, a thermal tempering treatment is applied.

Thus, according to the invention, it is possible to use existing steels, steel alloys or superalloys which are incombustible in the presence of burning titanium. These steels or superalloys are also thermally compatible (thermal treatment compatibility and similar or higher expansion coefficients) with titanium or titanium-based alloys, also already used in manufacturing compressor housings, in particular high-pressure turbojet compressors.

The superalloys(s) according to the invention may advantageously be cobalt- or nickel-based.

The invention also concerns a housing including at least a part constituting the structure holding the rows of stator blades, and an inner wall demarcating the outer contour of a compressor airstream in which are mounted rows of rotating rotor blades individually sandwiched with the rows of stator blades and means of thermal protection against burning titanium, wherein it includes at least along one part of its length, as a load-bearing structure, a part which is roll-bonded with a layer of titanium or titanium alloy and a layer of steel, steel alloy or superalloy, which is incombustible in the presence of burning titanium, and where the layer of steel, steel alloy or superalloy constitutes the means of thermal protection and the inner wall demarcating the outer contour of the compressor airstream.

The preferred material for the inner layer made from steel, steel alloy is chosen from among Inconel® 909 or Inconel® 783 or a stainless alloy of the 18-8 type.

A particularly advantageous titanium alloy for the outer layer is chosen from among Ti 6 4, Ti 6242 or Ti 6246.

According to a variant, the roll-bonded part can be of a length corresponding to only one part of the annular length of the housing.

On the inner diameter of the roll-bonded part, or downstream from the length to which it is attached, a wear material suitable for defining the outer contour of the airstream can be attached or applied, for example using a plasma technique. This wear material constitutes the abradable opposite the rotor blades, i.e. a material capable of being planed or eroded by the friction of the rotating blade heads against the housing.

The invention also concerns a high-pressure axial compressor comprising, as a stator, a housing as previously defined.

According to an advantageous embodiment, the length of the housing constitutes only the part upstream from the compressor, where the inner wall demarcating the outer contour of the downstream airstream is made from titanium or titanium alloy.

Finally, the invention concerns an aircraft engine including a compressor as referred to above.

### BRIEF DESCRIPTION OF THE ILLUSTRATIONS

Other characteristics and advantages of the invention will be seen more clearly on reading the detailed description below, made with reference to the following figures, among which:

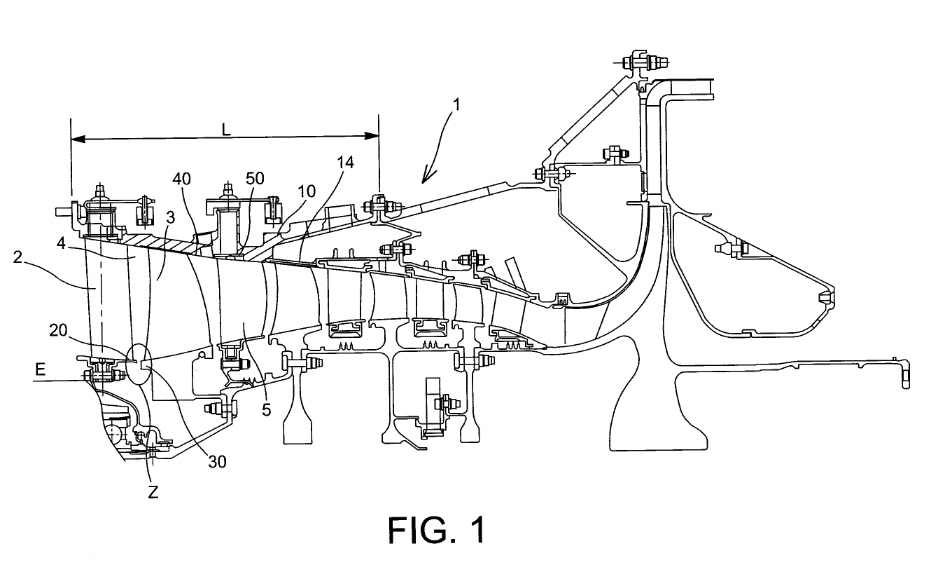

FIG. 1 is a lengthways section view of a high-pressure axial compressor of an aircraft turbojet according to the invention,

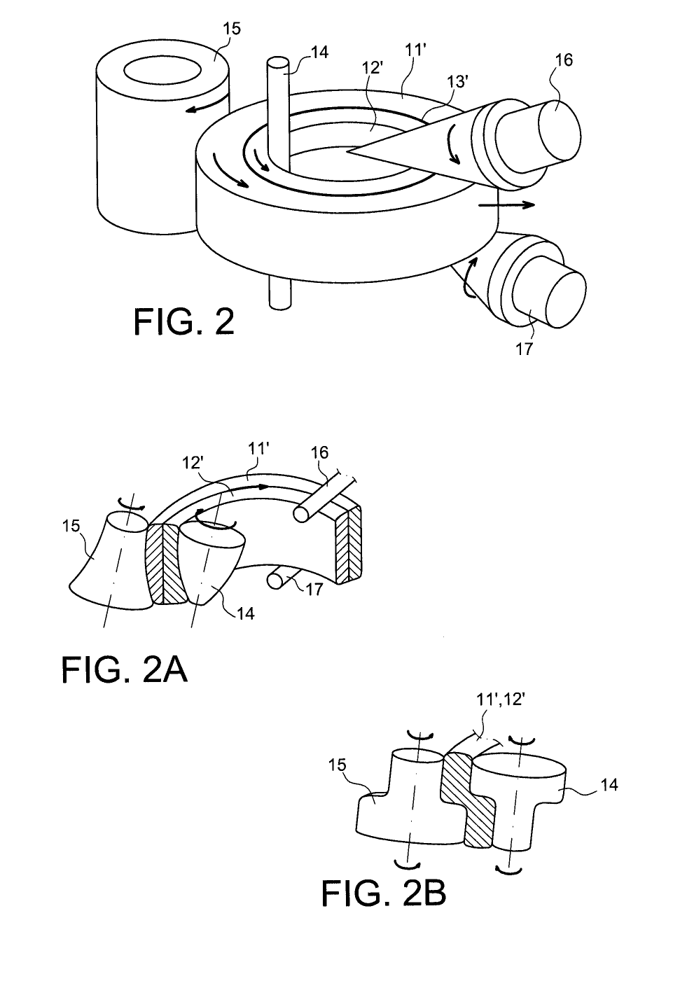

FIG. 2 is a perspective view of a step of the method for the manufacture of a circular revolution thermomechanical part according to a first embodiment of the invention,

FIGS. 2A to 2C show different advantageous variants of the method according to FIG. 2;

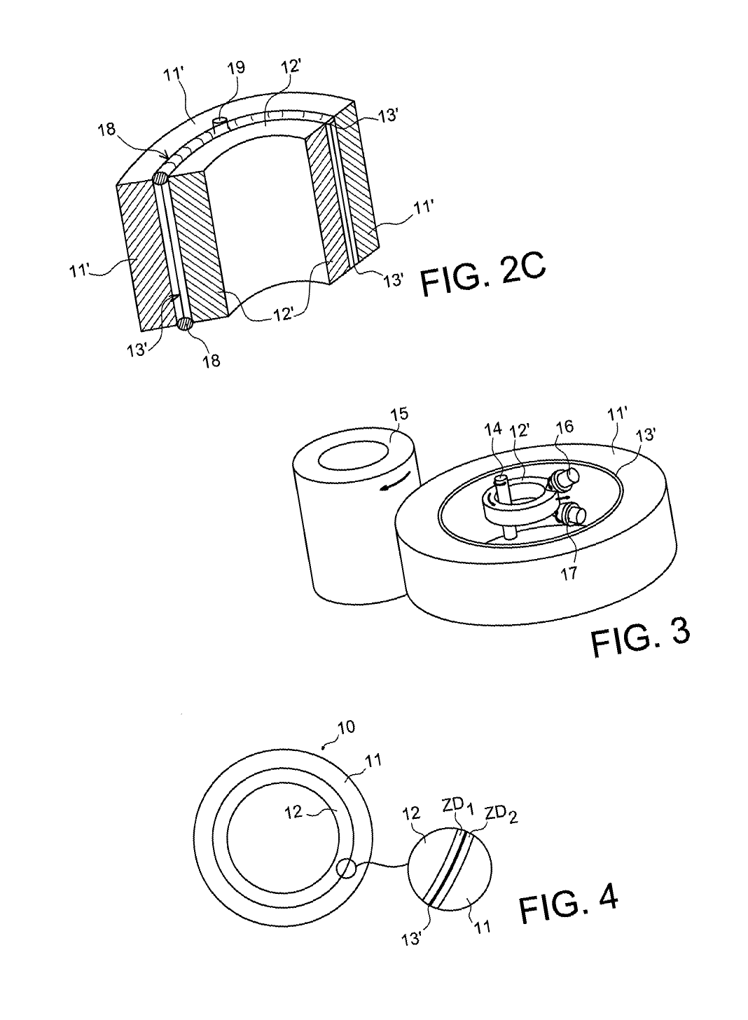

FIG. 3 is a perspective view of a step of the method for the manufacture of a circular revolution thermomechanical part according to a second embodiment of the invention,

FIG. 4 shows a detailed, cross-section, schematic view of a compressor housing obtained according to the method of the invention.

### DETAILED ACCOUNT OF PARTICULAR EMBODIMENTS

In FIG. 1 a high-pressure compressor 1 of a new-generation turbojet, i.e. with high pressures at inlet E, has been represented.

This type of compressor 1 includes a first row of gas diffusion stator blades 2 upstream from a first row of rotor blades 3. All the blades 2, 3 are made from titanium or titanium alloy. During the operation of the turbojet there is a risk of severe contact by friction between the base 20 of the stator blades 2 and the base 30 of the rotor blades 3 in the zone Z illustrated in FIG. 1.

This risk of severe contact by friction may lead to ignition of the titanium in this zone Z. It is then necessary to prevent burning titanium particles from propagating the combustion to the outer housing 10. Indeed, such particles can be expelled in the airstream of the gases 4 and as a result come into contact with the outer housing 10. The risk of contact is greater with the downstream part of the latter 10, which extends over a certain length L. This length L is the distance between two points, one of which marks the inversion of the inclinations in the profile of the housing, and the other of which is a mating surface with the downstream structure of the HP compressor, which becomes a superalloy structure in a gas stream.

If this outer housing 10 is made exclusively of titanium or titanium alloy, a titanium fire can then be created and thus spread to all the other parts constituting the turbojet.

To prevent this, according to the invention, an outer housing 10 is manufactured from a roll-bonded part the outer layer 11 of which is made from titanium or titanium alloy, and the inner layer 12 of which is made from steel or superalloy which is incombustible in the presence of burning titanium. The inner layer 12 made from steel or superalloy which is incombustible in the presence of burning titanium thus constitutes in a certain sense a fire-proofing shield for the load-bearing structure, against any burning titanium particle which might enter this part L of the housing 10.

The inner wall 12 of the housing demarcating the outer contour 40 of the compressor airstream 4 is thus constituted by the layer of steel or superalloy.

In the illustrated embodiment the outer layer 11 is made from titanium alloy Ti 6.4. The inner layer 12 is made from a low expansion coefficient alloy such as Inconel® 909 or 783. According to the invention, in order to obtain the housing 10 according to the invention, one proceeds as follows:

Firstly, hot forming is accomplished preferably by pre-rolling or by alpha-beta or beta forging of a circular preform 11′ (cylindrical or conical) made from titanium alloy Ti 6.4, giving it the shape of an annular ring. This step can also be accomplished by mass machining.

In parallel a circular preform 12′ made from Inconel® 909 steel alloy is produced, also in the shape of an annular ring, of diameter less than the ring 11′.

The inner surface of the ring 11′ and the outer surface of the ring 12′ are then machined and cleaned, so that surfaces free of pollutants and oxides are obtained.

A film 13′ made of anti-diffusion material(s) based on Mo, Ni or Sn is then inserted between the two machined rings 11′ and 12′.

At this stage two alternatives are possible to accomplish the ring rolling of the rings 11′ and 12′ between which the refractory film 13′ is inserted.

In the embodiment of FIG. 2 a concomitant circular roll-bonding of rings 11′ and 12′ is accomplished, between which the anti-diffusion film 13′ is inserted, using a hot ring rolling technique disclosed, for example, by the publication entitled “A summary of ring rolling technology. I—Recent trends in machines, processes and production lines”, bit. Mach. Tools Manufact. Vol. 32, no 3, 1992, P. 379-398, made by the authors Eruç E., Shivpuri R. Thus, two mandrels with vertical axes 14, 15 reduce concomitantly the thickness of the two rings 11′ and 12′ of the same initial height, increasing their diameters. The two conically shaped mandrels 16, 17 with horizontal axes limit the increase of their height likely to result from this.

The two mandrels with vertical axes 14, 15, the function of which is to reduce concomitantly the thickness of the two rings 11′, 12′ can, depending on the final shape of the housing which it is desired to obtain, have different shapes: straight cylindrical (FIG. 2), tapering (FIG. 2A), flared (FIG. 2B). In the case of a tapering or flared shape both mandrels are positioned facing one another, top to tail.

The two mandrels 16, 17 with horizontal axes the function of which is to limit the increase in height of the rings 11′, 12′ likely to result from their roll-bonding, can also have a straight cylindrical shape (FIG. 2A).

To prepare advantageously for the assembly of the whole constituted by both rings 11′ and 12′ before their roll-bonding they can be attached together temporarily. This temporary attachment may be accomplished, for example, by means of welding beads 18 at the lateral ends 11′a, 12′a, 11′b, 12′b of the rings 11′ and 12′, which also enable the anti-diffusion film 13′ to be positioned and attached (FIG. 2C). It is also possible to choose to make a vacuum in the free space between the film 13′ and each of the rings 11′, 12′, for example by pumping from a connection orifice 19 made in a bead 18 (FIG. 2C).

In the embodiment of FIG. 3 ring rolling is applied only to the inner ring 12′ made from Inconel® 909, until it is in contact with the anti-diffusion film 13′ and the outer ring 11′, and by this means material diffusion zones can be created at the interface. In this case the same technique of hot ring rolling is used, as disclosed, for example, by the publication entitled “A summary of ring rolling technology. I—Recent trends in machines, processes and production lines”, bit. Mach. Tools Manufact. Vol. 32, no 3, 1992, P. 379-398, made by the authors Eruç E., Shivpuri R.

In this case, both the mandrels with vertical axes 14, 15 reduce only the thickness of the ring 11′ by increasing its diameter. Both cones 16, 17 with horizontal axes limit the increase of its height likely to result from this, until the height of the ring 12′ made from titanium alloy Ti 6.4 is reached.

Whichever ring rolling alternative is used (FIG. 2 or FIG. 3), a thermal tempering treatment of the titanium alloy Ti 6.4 is then applied, so as to preserve the mechanical properties of the roll-bonding structure 11′, 12′ produced in this manner. Typically, this tempering is applied at a temperature of the order of 590 to 650° C. Using the method according to the invention, a circular revolution thermomechanical part is obtained the density of which is between 4.7 and 5.8 kg/dm³.

In FIG. 4A, it can be seen that the anti-diffusion film 13′ demarcates two zones ZD1 and ZD2 which are of mixed composition, in which the material(s) of the film are blended respectively with the titanium or the steel. More precisely, the composition of zone ZD1 is a blend of steel and the material(s) constituting the barrier film 13′, whereas the composition of zone ZD2 is a blend of titanium and the material(s) constituting the barrier film 13′.

To finish the circular revolution thermomechanical part 11′, 12′ obtained according to the method of the invention, and to achieve the housing 10, the steps of machining, inspection and finishing traditionally used in the manufacture of turbojet compressor housings are followed.

The outer housing 10 roll-bonded according to the invention enables a load-bearing structure 11 made from titanium alloy (Ti 6 4, 6242 or 6246, for example) to be retained, protected from risks of titanium fire by the inner layer 12.

Moreover, using the circular roll-bonding method according to the invention, the inner layer made of steel or superalloy in a certain sense constitutes a part of the load-bearing structure and also contributes to the mechanical properties of the housing.

The invention as described enables:

A/ the airstream of the high-pressure compressors to be protected by means of an alloy which is incombustible when exposed to a titanium fire,

B/ the outer part or load-bearing structure to be manufactured with a titanium alloy outside the zone potentially concerned by the titanium fire,

C/ a substantially lower mass to be maintained, compared to solutions involving housings made completely of steel or superalloy. For example, it may be permitted to envisage an outer housing 10, using as the roll-bonded inner layer Inconel® 909 of the order of 1 to 2 mm, as produced along the length L in the illustrated embodiment, having a weight approximately 10 kg lower than a housing of identical shape and dimensions made entirely from Inconel® 909. Thus, the “average” density of the housing according to the invention is equivalent to that of a housing made from alloys derived from titanium said to be fire-proof.

1-16. (canceled)

17. A method for manufacture of a circular revolution thermomechanical part including a load-bearing substrate made from titanium or titanium alloy lined with a steel, a steel alloy, or a superalloy, the method comprising:
a) production of a titanium or titanium alloy preform having a general shape of an annular ring;
b) production of a preform made from steel, steel alloy, or superalloy which is incombustible in presence of burning titanium, having a general shape of an annular ring of diameter less than the titanium or titanium alloy ring;
c) machining and/or piercing at least an inner surface of the titanium or titanium alloy ring;
d) assembly of the ring made from steel, steel alloy, or superalloy in the machined and/or pierced ring made from titanium or titanium alloy; and
e) ring rolling at least the ring made from steel, steel alloy, or superalloy until materials diffusion zones are created at an interface with the inner surface of the machined and/or pierced ring made from titanium or titanium alloy, wherein process conditions of the rolling are such that the created diffusion zones have no fragile phases during any thermal treatment(s) and during thermomechanical cycles to which the part is subsequently subjected.

18. A method according to claim 17, wherein the production a) includes pre-rolling or alpha-beta forging of a titanium alloy.

19. A process according to claim 17, wherein the production b) includes pre-rolling or drawn rolled welded techniques or forging-piercing of a steel, a steel alloy, or a superalloy.

20. A method according to claim 17, wherein, in the machining and/or piercing c), a machining and/or a piercing of an outer surface of ring made of steel, steel alloy, or superalloy is accomplished.

21. A method according to claim 17, wherein, in course of the assembly d), a film made from anti-diffusion material(s) based on Mo, Ni, or Sn is inserted between the ring made from steel, steel alloy, or superalloy and the machined and/or pierced ring made from titanium or titanium alloy, wherein a thickness and chemical composition of the film are chosen both to produce a diffusion barrier between the titanium and the steel, steel alloy, or superalloy, and to create diffusion zones between firstly the film and the titanium or titanium alloy, and secondly the film and the steel, steel alloy, or superalloy.

22. A method according to claim 17, wherein the ring rolling e) is performed in an alpha-beta field of the titanium or titanium alloy.

23. A method according to claim 17, wherein the ring rolling e) includes concomitant ring rolling of the ring made from steel, steel alloy, or superalloy and the ring made from titanium or titanium alloy, wherein both rings are rolled one against the other by at least two rolling mandrels with vertical axes, each positioned outside one of the rings.

24. A method according to claim 17, wherein, after the ring rolling e), when the steel is a low expansion coefficient steel, a thermal tempering treatment is applied.

25. A housing comprising:
at least a part constituting a structure holding rows of stator blades;
an inner wall demarcating an outer contour of a compressor airstream in which are mounted rows of rotating rotor blades individually sandwiched with the rows of stator blades; and
means for thermal protection against burning titanium, including at least along one part of its length, as a load-bearing structure, a part which is roll-bonded with a layer of titanium or titanium alloy and a layer of steel, steel alloy, or superalloy, which is incombustible in presence of burning titanium, and wherein the layer of steel, steel alloy, or superalloy constitutes the means of thermal protection and an inner wall demarcating the outer contour of the compressor airstream.

26. A housing according to claim 25, wherein the steel, steel alloy, is chosen from among Inconel® 909, Inconel® 783, or a stainless alloy of 18-8 type.

27. A housing according to claim 25, wherein the titanium alloy is chosen from among Ti 6 4, Ti 6242, or Ti 6246.

28. A housing according to claim 25, wherein a length of the roll-bonded part corresponds only to a part of an annular length of the housing.

29. A housing according to claim 25, wherein over an inner diameter of the roll-bonded part, or downstream from a length along which it is installed, a wear material configured to define the outer contour of the airstream is attached or applied.

30. A high-pressure axial compressor comprising, as a stator, a housing according to claim 25.

31. A high-pressure compressor according to claim 30, wherein a length of the housing constitutes only an upstream part of the compressor, and wherein the inner wall demarcating the outer contour of the downstream airstream is made from titanium or titanium alloy.

32. An aircraft engine comprising a compressor according to claim 30.
